(19) United States
(12) Patent Application Publication
(10) Pub. No.: US 2020/0279581 A1
(43) Pub. Date: Sep. 3, 2020

(54) MAGNETIC RECORDING MEDIUM AND MAGNETIC RECORDING AND REPRODUCING DEVICE

(71) Applicants: Kabushiki Kaisha Toshiba, Tokyo (JP); Toshiba Electronic Devices & Storage Corporation, Tokyo (JP)

(72) Inventor: Mio Okada, Yokohama Kanagawa (JP)

(21) Appl. No.: 16/455,867

(22) Filed: Jun. 28, 2019

(30) Foreign Application Priority Data
Feb. 28, 2019 (JP) 2019-036145

(51) Int. Cl. G11B 5/73; G11B 5/72

(52) U.S. Cl. CPC G11B 5/736; G11B 5/72

(57) ABSTRACT

According to one embodiment, a magnetic recording medium includes a surface area including a pair of main surfaces and a side provided between the main surfaces, a recording area formed to carry out magnetic recording, a non-recording area other than the recording area and a contaminant collecting portion provided in at least a part of the surface area within the non-recording area and having a surface free energy higher than a surface free energy of the surface area within the recording area.

### CROSS-REFERENCE TO RELATED APPLICATIONS

This application is based upon and claims the benefit of priority from Japanese Patent Application No. 2019-036145, filed Feb. 28, 2019, the entire contents of which are incorporated herein by reference.

### FIELD

Embodiments described herein relate generally to a magnetic recording medium and a magnetic recording and reproducing device.

### BACKGROUND

Magnetic recording media of HDDs entail a problem that a contaminant as cyclic siloxane, created by outgas, adheres to a surface of a medium to contaminate an element of a head, causing the occurrence of recording or reproduction errors. One of the examples of the pathways for entering of contaminant is a gap between plates of an outer circumferential portion of a cylinder in which a plurality of media are staked, via which a contaminant enters and attaches to the surface of a medium. To prevent this, there is a conventional attempt of reducing the possibility of contaminants attaching to media by placing activated carbon in the drive to adsorb the contaminants. However, lubricant is applied uniformly on the surfaces and the edge surfaces of the media, and therefore contaminants not adsorbed by activated carbon, in particular, those existing in the vicinities of the outer circumferences of the media, cannot be prevented actively from entering from the gap between the plates. For this reason, contaminants enter easily from the gap between the plates, significantly increasing the possibilities that contaminants attach on the large-area surfaces of the media. Thus, the frequency of occurrence of failure undesirably increases.

### BRIEF DESCRIPTION OF THE DRAWINGS

FIG. 1 is a plan view of a hard disk drive according to an embodiment.

FIG. 2 is a cross section schematically showing a structure of a magnetic recording medium according to the embodiment.

FIG. 3 is a decomposed perspective view showing the hard disk drive according to the embodiment.

FIG. 4 is a cross section of the HDD taken along line E-E in FIG. 3.

FIG. 5 is a cross section schematically showing a structure of a magnetic recording medium according to another embodiment.

FIG. 6 is a partially enlarged view schematically showing a part of FIG. 5.

FIG. 7 is a schematic diagram showing a removal system of lubrication application layer.

FIGS. 8A, 8B and 8C are diagrams each illustrating a part of FIG. 7.

### DETAILED DESCRIPTION

In general, according to one embodiment, a magnetic recording medium includes a recording area formed to carry out magnetic recording, and a non-recording area other than the recording area. The magnetic recording medium comprising a surface area including a pair of main surfaces and a side provided between the main surfaces, and a contaminant collecting portion provided in at least a part of the surface area within the non-recording area, and having a surface free energy higher than a surface free energy of the surface area within the recording area.

Magnetic recording media and magnetic recording and reproducing devices according to embodiments will now be described with reference to drawings.

What is disclosed in this specification is merely an example. Appropriate modifications which can be easily conceived by a person ordinarily skilled in the art without departing from the spirit of the embodiments naturally fall within the scope of the present invention. To further clarify explanation, for example, the width, thickness or shape of each structure may be schematically shown in the drawings compared with the actual forms. Note that the drawings are merely examples and do not limit the interpretation of the present invention. In the specification and drawings, elements which are identical to those of the already-mentioned figures are denoted by the same reference numbers. Thus, the detailed explanation of such elements may be omitted.

### First Embodiment

As a magnetic recording and reproducing device, a hard disk drive (HDD) according to the first embodiment will now be described in detail.

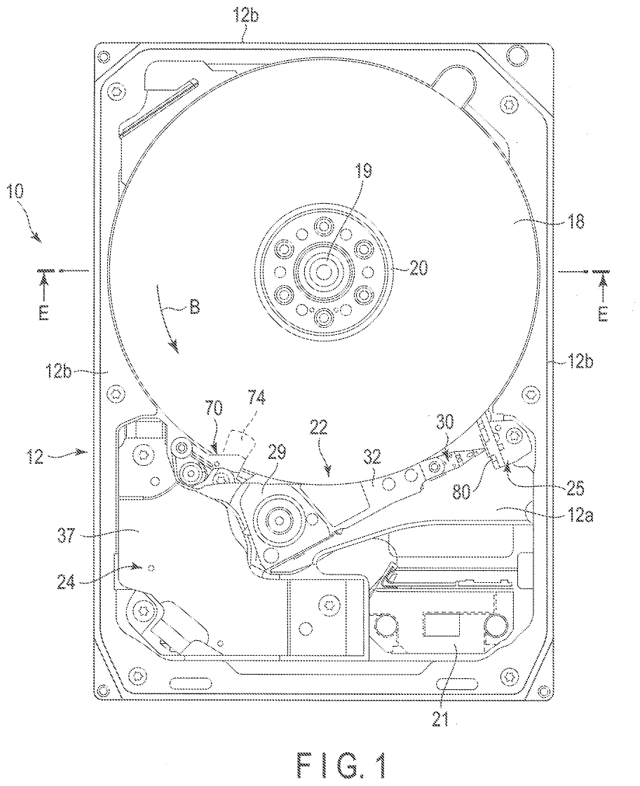

FIG. 1 is a plan view of the HDD without its cover.

As shown in FIG. 1, the HDD comprises a rectangular housing 10. The housing 10 comprises a rectangular box-shaped base 12 with an upper surface being opened, and a cover (top cover) which is not illustrated. The base 12 comprises a rectangular bottom wall 12a and side walls 12b provided to rise along peripheral edges of the bottom wall 12a, which are all formed of, for example, aluminum, so to be integrated as one body. The cover can be formed, for example, from stainless steel into a rectangular plate shape, and can be screwed on the side wall 12b of the base 12 so as to airtightly block the upper surface opening of the base 12.

As shown in FIG. 1, the housing 10 accommodates magnetic disks 18 as a disk-like magnetic recording media and a spindle motor 19 provided to support and rotate the magnetic disks 18. The spindle motor 19 is disposed on the bottom wall 12a. Each of the magnetic disks 18 comprises a substrate formed into, for example, a disk shape having a diameter of 95 mm (3.5 inches) of a nonmagnetic material, for example, glass, and a magnetic recording layer formed on an upper surface (first surface) of the substrate. The magnetic disk 18 is fit with a hub of the spindle motor 19 and further clamped with a clamp spring 20. In this manner, the magnetic disks 18 are supported parallel to the bottom wall 12a of the base 12. The magnetic disks 18 are rotated by the spindle motor 19 at a predetermined speed rate in a direction indicated by an arrow B.

The housing 10 accommodates therein a plurality of magnetic heads 17 which record and reproduce information on and from the magnetic disks 18, and a head actuator assembly 22 which supports the magnetic heads 17 such that they are movable with respect to the magnetic disks 18. Further, the housing 10 accommodates a voice coil motor (VCM) 24 which rotates and positions the actuator assembly 22, a ramped loading mechanism 25 which holds the magnetic heads 17 at an unloading position spaced away from the magnetic disks 18 when the magnetic heads 17 are moved to the outermost circumference of the magnetic disks 18, a board unit (FPC unit) 21 on which electronic components including a conversion connector are mounted, and a spoiler 70.

A printed circuit board 27 is fixed by a screw to an outer surface of the bottom wall 12a of the base 12. The printed circuit board constitutes a control unit which controls the operation of the spindle motor 19, and also controls the operation of the VCM 24 and the magnetic heads 17 via the board unit 21.

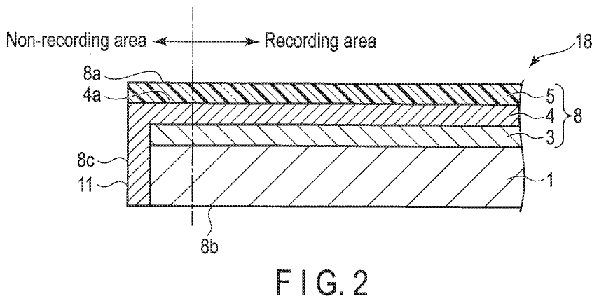

FIG. 2 is a cross section schematically showing a structure of the magnetic recording media used for the HDD according to the first embodiment.

As shown, this magnetic disk 18 comprises a substrate 1 and a multilayer 8 provided on the substrate 1, and the multilayer 8 includes a magnetic recording layer 3, a protective layer 4 provided on the magnetic recording layer 3, and a lubricating layer 5 provided on the protective layer 4. The magnetic recording medium 18 comprises surface regions including a pair of main surfaces 8a and 8b and a side surface 8c provided between the main surfaces 8a and 8b. Further, the magnetic recording medium 18 comprises a recording area for carrying out magnetic recording and reproduction, and a non-recording area other than the recording area. Here, the side surface 8c in the non-recording area includes a portion where the protective layer 4 is exposed as a contaminant collecting portion 11.

As the substrate 1, a nonmagnetic substrate such as a glass substrate or an aluminum alloy substrate, can be employed. The aluminum alloy substrate used in this embodiment includes an aluminum plate and an alloy layer formed on the aluminum plate. For the protective layer 4, diamond-like carbon (DLC) generated by chemical vapor deposition (CVD), for example, can be used. A usable example of the lubricating layer is perfluoropolyether. The surface free energy of the protective layer made of carbon is higher than the surface free energy of the lubricating layer made of perfluoropolyether.

According to the first embodiment, the surface free energy of the contaminant collecting portion 11 of the side surface 8c in the non-recording area is higher than the surface free energy of the lubricating layer of the recording area. With this configuration, contaminants such as outgas concentrate on the contaminant collecting portion 11, to become easily attachable thereto. Thus, it is possible to inhibit contaminants from attaching to the lubricating layer surface in the recording area.

### Second Embodiment

An HDD according to the second embodiment will now be described in detail.

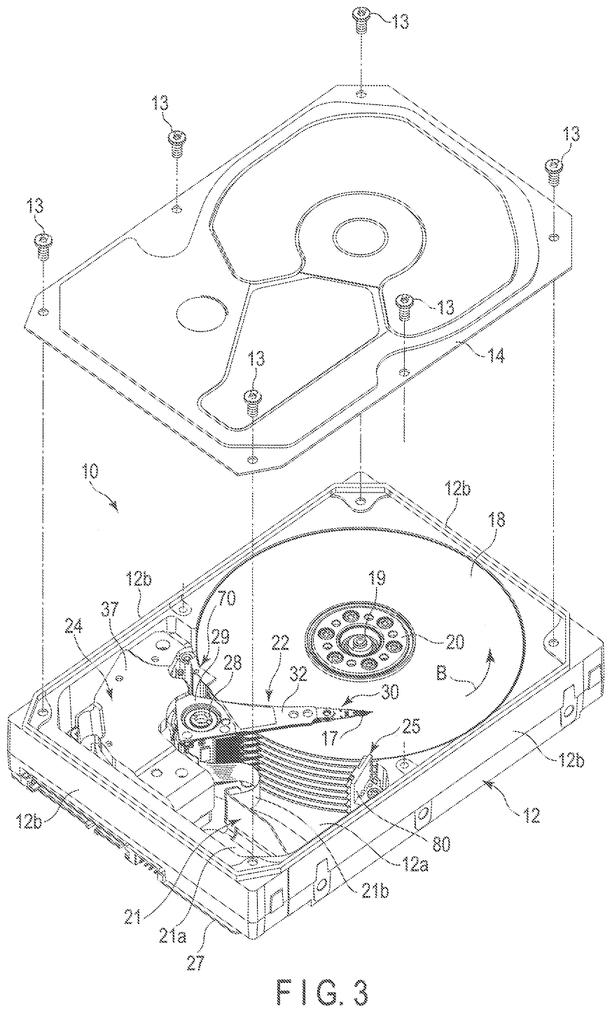

FIG. 3 is an exploded perspective view of the HDD according to this embodiment, in which the cover thereof is removed.

As shown the HDD according to the second embodiment has a structure similar to that shown in FIG. 1 except that a plurality of magnetic disks disposed to oppose each other are used as the magnetic disks 18, and the HDD comprises, as actuator assembly 22, a plurality of arms 17, suspension assemblies (head gimbal assemblies, which may be referred to as HGA) 30 attached to the arms 32, respectively, and magnetic heads 17 supported by the suspension assemblies 30, respectively.

The magnetic disks each comprise a substrate of glass, and magnetic recording layers formed on an upper surface (first surface) and a lower surface (second surface) of the substrate. The magnetic disks 18 are fitted coaxially with each other on a hub), which will be described later) of the spindle motor 19, and are clamped by a clamp spring 20. The number of the arms 32 is greater by one than the number of the magnetic disks. Moreover, the number of the magnetic heads 17 is twice the number of the magnetic disks.

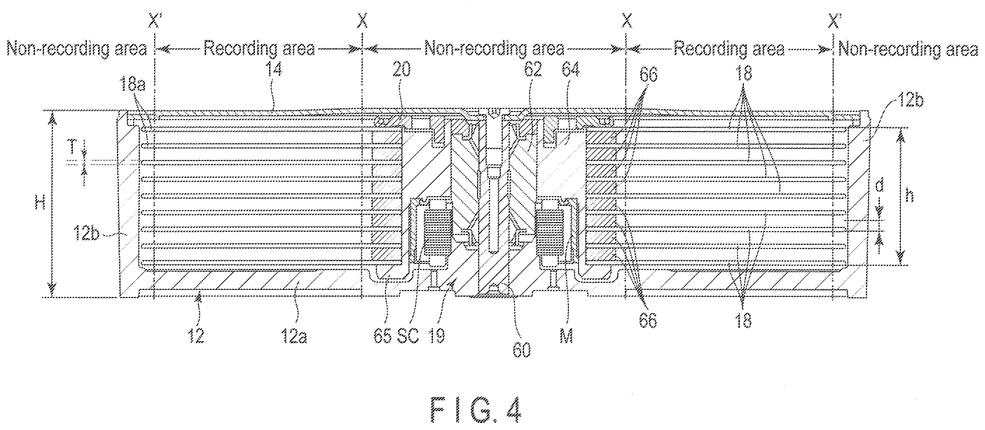

FIG. 4 is a cross section of the HDD taken along line E-E of FIG. 3.

In this example, the spindle motor 19 includes a shaft 60 provided to stand substantially up right on the bottom wall 12a, a cylindrical pivot 62 rotatably supported around the shaft 60, a substantially cylindrical hub 64 fixed around the pivot 62 coaxially, a stator coil SC fixed to the bottom wall 12a and disposed around the pivot 62, and a cylindrical magnet M attached on an inner circumferential surface of the hub 64 so as to face the stator coil SC. The hub 64 comprises an outer circumferential surface located coaxial with the shaft 60 and an annular flange 65 formed in a lower end (on a bottom wall 12a side) of the outer circumferential surface so as to be integrated therewith.

The magnetic disks 18 are engaged with the outer circumferential surface of the hub 64 while the hub 64 inserted to inner holes thereof. Further, annular spacer rings 66 are each mounted around the outer circumferential surface of the hub 64 so as to be interposed between each respective adjacent pair of two magnetic disks 18. The magnetic disks 18 and the spacer rings 66 are disposed on and above the flange 65 of the hub 64 in order, and are attached to the hub 64 while stacking one on another alternately. Here, the clamp spring 20 attached to the upper end of the hub 64 pressurizes the inner circumferential portions of the magnetic disks 18 and the spacer rings 66 to the flange 65 side, thus fixating the magnetic disks 18 in a stacked state while keeping predetermined intervals between each other. Thus, nine of the magnetic disks 18 are integrally supported by the pivot 62 and the hub 64 so as to be rotatable therewith. Further, the nine magnetic disks 18 are supported to be parallel to each other while keeping predetermined gap therebetween, and also substantially parallel to the bottom wall 12a.

The housing 10 is formed to have a height (thickness) H of a maximum of 26.1 mm in accordance with the HDD standard. The magnetic disks 18 are each formed to have a thickness T of, for example, 0.635 mm and arranged to have a gap d between each adjacent pair of two magnetic disks 18), which is equivalent to the thickness of the spacer rings) of, for example, 1.58 mm. In this embodiment, a stack height h of all the magnetic disks (the height from the lower surface of the lowermost magnetic disk to the upper surface of the topmost magnetic disk) is set to 18.356 mm.

As shown, in each of the nine magnetic disks 18, for example, when a region between X-X′ is formed as a recording area, an inner circumferential region with respect to X and an outer circumferential region with respect to X′ are non-recording areas. The contaminant collecting portion 11 can be formed in the non-recording areas.

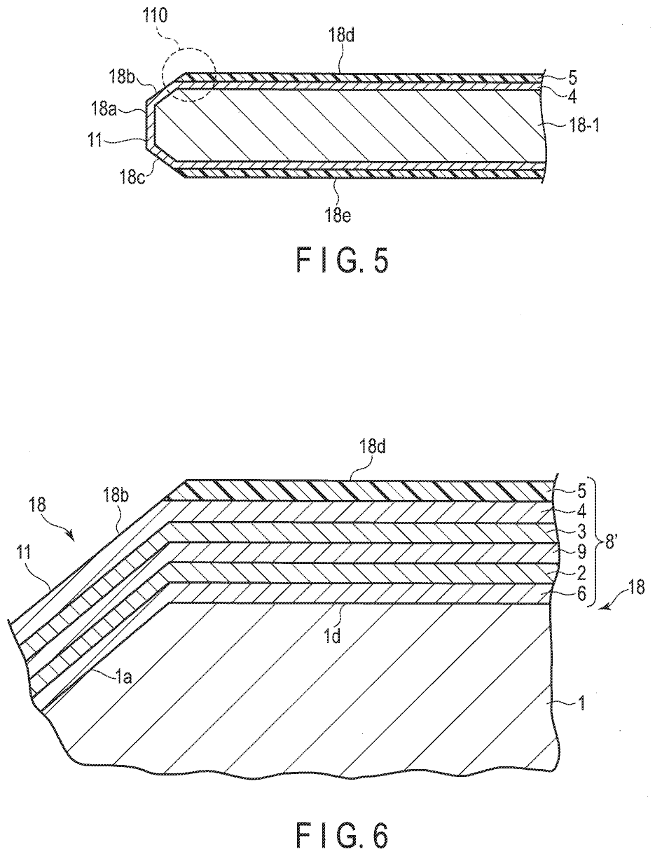

Next, the structure of the magnetic recording media used for the HDD according to the second embodiment will be described with reference to FIGS. 5 and 6.

FIG. 5 shows the configuration of the outer circumferential edge surface of one of the magnetic disks 18 shown in FIG. 4.

As shown, this magnetic disk 18 includes a structure that the protective layer 4 and the lubricating layer 5 are stacked on each of both surfaces of the substrate 18-1 which includes magnetic recording layers, and comprises a pair of main surfaces 18d and 18e, and a side surface 18a formed between the main surfaces 18d and 18e. Further, a chamfered portion 18c is formed between the main surface 18d and the side surface 18a, and a chamfered portion 18b is formed between the side surface 18a and the main surface 18e. Further, a lubricating layer 5 is formed on each of the main surfaces 18d and 18e, and the side surface 18a and the chamfered portions 18b and 18c are formed as a portion where the protective layer 4 is exposed from the lubricating layer 5, which is the contaminant collecting portion 11.

FIG. 6 is a partially enlarged diagram schematically showing the configuration of a region surrounded by a dotted line 110 in FIG. 5.

As shown, the magnetic recording medium 18 includes a substrate 1, and a multilayer 8′ provided on the substrate 1 and containing a magnetic recording layer 3. The substrate 1 comprises a main surface 1d, another main surface (not shown) opposing the main surface 1d, and an edge surface of the substrate 1. The edge surface further comprises a side surface (not shown) formed between the main surfaces, a chamfered portion 1a provided between the main surface 1d and the side surface and another chamfered portion provided between the main surface and the side surface.

As in the case of the substrate used in the first embodiment, the substrate 1 can be formed from a nonmagnetic substrate such as a glass substrate or an aluminum alloy substrate.

The multilayer 8′ includes a soft magnetic underlying layer 6, a seed layer 2 and an intermediate layer 9 stacked in order on the substrate 1, and a magnetic recording layer 3 provided on the intermediate layer 9.

A usable example of the material for the soft magnetic underlying layer (SUL) 6 is an amorphous alloy containing at least one selected from Fe, Co and Ta as main ingredients and an additional ingredient selected from Zr, B and Si, and FeCoTa is used here.

As the seed layer 2, Ni, W and the like can be used, and NiW is used here.

As the intermediate layer (IL) 9, a Ru alloy can be used. Cr or the like can be added to the Ru alloy in consideration of matching with the grid of the in-plane direction. Here, RuCr is used.

On the intermediate layer 9, the magnetic recording layer (Mag) 3 can be formed. As the magnetic recording layer, a continuation film and a granular film containing, for example, CoPt as the main ingredients can be used. Here, CoPtCr is used.

For the manufacture of the magnetic disk 18 of such a structure, first, a nonmagnetic substrate such as of glass is prepared, and washed with pure water, followed by drying. Thereafter, the substrate is accommodated in a film-forming chamber of a DC magnetron sputtering device. Then, the film-forming chamber is evacuated. While maintaining a fixed degree of vacuum, Ar gas is introduced at a predetermined gas-pressure for each of the soft magnetic underlying layer 6, the seed layer 2, the intermediate layer 9, and the magnetic recording layer 3 to form them in the order.

After forming the magnetic recording layer 3, a C-protective layer 4 is formed by generating diamond-like carbon (DLC), for example, by the chemical vapor deposition (CVD) method.

Subsequently, the lubricating layer 5 is formed as follows.

After the step described above, a lubricant coating layer is formed on the DLC surface by performing, for example, dip coat with a lubricant on the surface of the protective layer 4. Here, the lubricant coating layer is formed from a bond lubricating layer adsorbed on the surface of the protective layer 4, and a free lubricating layer provided on the bond lubricating layer, but not adsorbed on the surface of the protective layer 4.

Next, the bond lubricating layer and free lubricating layer of the lubricant coating layer on the side surface and the chamfered portion of a substrate 18-2 on which the lubricant coating layer is provided, are removed with a vanishing tape containing abrasives to expose the protective layer, and thus, the contaminant collecting portion 11 is obtained.

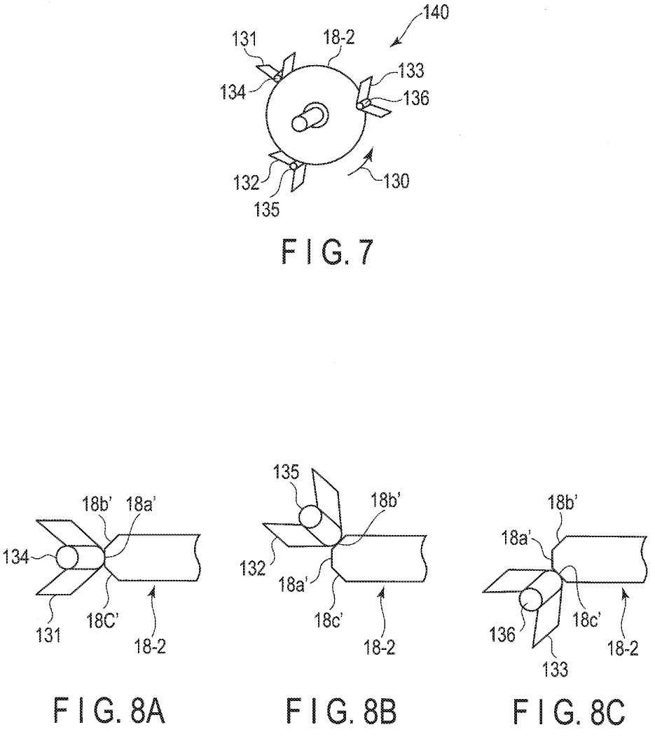

FIG. 7 is a schematic diagram showing a removal system 104 for the lubricant coating layer.

Further, each of FIGS. 8A, 8B and 8C illustrates a part of FIG. 7.

As shown, the lubricant-coating-layer removal system 140 includes three abrasive-containing vanishing tapes 131, 132 and 133, pressurization members 135, 136 and 137 contactable on the vanishing tapes 131, 132 and 133, respectively, and a driver (not shown) which rotate the substrate 18-2 in a direction indicated by an arrow 130.

FIGS. 8A, 8B and 8C are schematic diagrams each showing arrangement of the vanishing tapes 131, 132 or 133 and the substrate 18-2. As shown in FIG. 8A, the vanishing tape 131 is disposed to be contactable on a side surface 18a′ of the substrate 18-2 by the pressurization member 134. As shown in FIG. 8B, the vanishing tape 132 is disposed to be contactable on a first chamfered portion 18b′ of the substrate 18-2 by the pressurization member 135. As shown in FIG. 8C, the vanishing tape 133 is disposed to be contactable on a second chamfered portion 18c′ of the substrate 18-2 by the pressurization member 136.

The lubricant-coating-layer removal system 140 operates as follows. That is, while rotating the substrate 18-2 in the direction of the arrow 130, the abrasive-containing vanishing tapes 131, 132 and 133 are pressed against the side surface 18a′, the first chamfered portion 18b′ and the second chamfered portion 18c′, respectively, at a constant pressure by the pressurization members 134, 135 and 136. Thus, the bond lubricating layer and the free lubricating layer of the lubricant coating layer can be removed to expose the protective layer on the side surface 18a′, the first chamfered portion 18b′ and the second chamfered portion 18c′, and thus the contaminant collecting portion can be prepared.

In this magnetic disk 18, the protective layers of all of the side surface 18a′, the first chamfered portion 18b′ and the second chamfered portion 18c′ are exposed, but it suffices if the protective layer of at least one of the side surface 18a′, the first chamfered portion 18b′ and the second chamfered portion 18c′ is exposed. Moreover, the protective layer of the side surface 18a′, the first chamfered portion 18b′ or the second chamfered portion 18c′ may not necessarily be entirely exposed, but it suffices if it is partially exposed.

The rest of the lubricant coating layer of the magnetic disk provided with the contaminant collecting portion can be hardened by heating it for 1 hour at 150° C. with a heater.

The thus obtained magnetic recording medium can be used for at least one of the nine magnetic disks 18 of the disk device. With this structure, contaminants can be attached intensively in the contaminant collecting portion provided on the side surface 18a′, the first chamfered portion 18b′ and the second chamfered portion 18c′, located on a side surface 18a′ side of the housing, and thus it is possible to reduce the rate of contaminants entering between a plurality of magnetic disks 18. In terms of suppressing the contamination entering between disks, it is effective when the magnetic disk provided the contaminant collecting portion is used for at least the second disk from the cover side to the eighth disk of the nine magnetic disks, and it is also possible to use it for all the magnetic disks.

Measurement of Surface Free Energy

The surface free energy of each of the lubricating layer 5 and the protective layer 4 was measured as follows.

A magnetic recording medium 18-3 comprising a lubricating layer on an outermost surface was formed in a similar manner to that of the magnetic recording medium shown in FIG. 6 except that the lubricant coating layer was not removed.

1 μl of a droplet the surface free energy of which is known was dropped on the medium and an angle between the medium and the droplet was measured with a contact angle meter. A similar measurement was carried out four times on within the medium surface. Using the formula of Young-Dupre, the surface free energy of the medium was calculated and the result was 26.0 mN/m. On the other hand, a magnetic recording medium 18-4 with a protective layer on an outermost surface was formed similarly except that the lubricant was not applied. The thus obtained medium was subjected to the contact angle measurement, and the surface free energy was 50.5 mN/m. Thus, it was found that the surface free energy is higher in this medium as compared with the medium with the lubricant applied on the outermost surface.

Evaluation of Attachment of Contaminant on Protective Layer and Lubricating Layer

The magnetic recording medium 18-3 with lubricant on the outermost surface was mounted in an HDD, and the drive was operated under an environment of 80° C. for 260 hours. Here, gas was generated from inside the HDD, and attached on the medium.

As the contaminant attachment evaluation, the amount of Si+ ion was measured with ToF-SIMS, and the result indicated the count was 500.

On the other hand, the magnetic recording medium 18-4 with the C-protective layer on the outermost surface without applying a lubricant was mounted in an HDD and a similar measurement was carried out. The count of Si+ ions was 2200, and thus the result indicated contaminants attach more easily than in the case of the magnetic recording medium 18-3.

As described above, it is understood that the surface free energy is higher in the protective layer than in the lubricating layer, and contaminants attach more easily.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic recording medium including a recording area formed to carry out magnetic recording, and a non-recording area other than the recording area,
the magnetic recording medium comprising:
a surface area including a pair of main surfaces and a side provided between the main surfaces; and
a contaminant collecting portion provided in at least a part of the surface area within the non-recording area, and having a surface free energy higher than a surface free energy of the surface area within the recording area.

2. The magnetic recording medium of claim 1, further comprising:
a multilayer including a nonmagnetic substrate, a magnetic recording layer provided on the nonmagnetic substrate, a protective layer provided on the magnetic recording layer and a lubricating layer provided on the protective layer,
wherein
the contaminant collecting portion includes a portion where the protective layer is exposed from the lubricating layer.

3. The recording medium of claim 1, wherein
the surface free energy of the contaminant collecting portion is 50.5 mN/m or higher.

4. The recording medium of claim 1, wherein
the magnetic recording medium has a disk-like shape, and
the non-recording area is formed in an inner circumference and an outer circumference of the recording area.

5. A magnetic recording and reproducing device comprising:
a magnetic recording medium comprising:
a surface area including a pair of main surfaces and a side provided between the main surfaces;
a recording area formed to carry out magnetic recording;
a non-recording area other than the recording area; and
a contaminant collecting portion provided in at least a part of the surface area within the non-recording area, and having a surface free energy higher than a surface free energy of the surface area within the recording area.

6. The device of claim 5, wherein
the magnetic recording medium further comprises:
a multilayer including a nonmagnetic substrate, a magnetic recording layer provided on the nonmagnetic substrate, a protective layer provided on the magnetic recording layer and a lubricating layer provided on the protective layer,
wherein
the contaminant collecting portion includes a portion where the protective layer is exposed from the lubricating layer.

7. The device of claim 5, wherein
the surface free energy of the contaminant collecting portion is 50.5 mN/m or higher.

8. The device of claim 5, wherein
the magnetic recording medium has a disk-like shape, and
the non-recording area is formed in an inner circumference and an outer circumference of the recording area.

9. The device of claim 5, wherein
the magnetic recording medium further comprises:
one or more magnetic recording media opposing each other at predetermined intervals.
